(19) United States
(12) Patent Application Publication
(10) Pub. No.: US 2026/0256149 A1
(43) Pub. Date: Sep. 3, 2026

(54) METHOD OF MAKING OAT FLOUR BASED FOOD COMPOSITION

(71) Applicant: Chobani LLC, Norwich, NY (US)

(72) Inventors: Justin Bolak, Kimberly, ID (US); Samuel Clarke, Twin Falls, ID (US); Jeff King, Twin Falls, ID (US); Erik Oberg, Twin Falls, ID (US)

(21) Appl. No.: 19/659,732

(22) Filed: Apr. 27, 2026

Related U.S. Application Data
(63) Continuation of application No. 18/746,955, filed on Jun. 18, 2024, now Pat. No. 12,610,958.
Application No. 18/746,955 is a continuation of application No. 16/935,666, filed on Jul. 22, 2020, now Pat. No. 12,035,723.

(51) Int. Cl. A21D 2/38

(52) U.S. Cl. CPC A21D 2/38

(57) ABSTRACT

A method of making an oat composition is provided. The method includes adding oat flour to water. The method further includes adding a first enzyme blend to the oat-water mixture. The method further includes increasing the temperature of the oat-water mixture with the first enzyme blend, and maintaining the increased temperature of the oat-water mixture with the first enzyme blend. The method further includes cooling the oat-water mixture. The method further includes adding a second enzyme blend to the oat-water mixture with the first enzyme blend. The method further includes removing an amount of solids from the third enzyme oat-water mixture to form the oat composition. The method is able to achieve higher yields, increased shelf stability, and lower waste from manufacturing compared to conventional oat-based food composition manufacturing methods.

### CROSS REFERENCE TO RELATED APPLICATIONS

This application is a continuation-in-part of U.S. Application No. 18/746,955, filed June 18, 2024, which is a continuation of U.S. Application No. 16/935,666, filed July 22, 2020 (US Pat. No. 12,035,723), the entireties of which are incorporated by reference herein.

### TECHNICAL FIELD

This disclosure relates to food products and methods and, in particular, to oat flour-based beverage and food products and methods of manufacturing oat flour based beverage and food products.

### BACKGROUND

Oat-based beverage and food products are known to be nutritious and may include oat milk therein. Oat milk may be used as a dairy substitute, and oat milk products have a benefit over conventional dairy products in that they avoid the use of lactose, which can be upsetting to consumers who are lactose intolerant. However, whole oat flour contains carbohydrates and fibers that are required to be broken down during processing to manufacture both low and high acid liquids or solid food formats.

Conventional oat-based food compositions cause high amounts of waste and have low yields. Additionally, due to the conventional methods used to break down carbohydrates in oats and oat flour, many conventional oat-based food compositions lack the ability to be stable for the long periods of time that they may be shelved or stored. Therefore, a need exists to newly or alternatively break down carbohydrates and fibers in whole oat flour for oat-based beverage and food product production to reduce waste, improve yields, and improve shelf stability. Furthermore, it is desirable to provide an oat-based food composition that can be incorporated into oat-based beverages and food products to exhibit desirable properties for use in those settings (e.g., having the oat milk function similarly to other types of milk).

### SUMMARY

In one embodiment, a method of making an oat composition is provided. The method includes adding oat flour to water to form an oat-water mixture. The method further includes adding a first enzyme blend to the oat-water mixture at a temperature between 10^{o}C and 30^{o}C, inclusively, to form a first enzyme oat-water mixture. The method further includes increasing the temperature of the first enzyme oat-water mixture to between 55^{o}C and 75^{o}C, inclusively. The method further includes adding an additional amount of the first enzyme blend to the first enzyme oat-water mixture after increasing the temperature of the first enzyme oat-water mixture to between 55^{o}C and 75^{o}C, inclusively, to form a second enzyme oat-water mixture. The method further includes maintaining, in a processing step, a temperature of the second enzyme oat-water mixture between 55^{o}C and 75^{o}C, inclusively. The method further includes cooling the second enzyme oat-water mixture to a temperature between 45^{o}C and 70^{o}C, inclusively. The method further includes adding another enzyme blend to the second enzyme oat-water mixture to form a third enzyme oat-water mixture. The method further includes maintaining a temperature of the third enzyme oat-water mixture between 45^{o}C and 70^{o}C, inclusively, during a further processing step. The method further includes removing an amount of solids from the third enzyme oat-water mixture to form the oat composition.

In another embodiment, a method of making an oat composition is provided. The method includes adding oat flour to water to form an oat-water mixture. The method further includes adding a first enzyme blend to the oat-water mixture at a temperature between 20°C and 30°C, inclusively, to form a first enzyme oat-water mixture. The method further includes increasing the temperature of the first enzyme oat-water mixture to between 75^{o}C and 95^{o}C. The method further includes adding a second enzyme blend to the first enzyme oat-water mixture after increasing the temperature of the first enzyme oat-water mixture to between 75^{o}C and 95^{o}C, inclusively, to form a second enzyme oat-water mixture. The method further includes maintaining, in a processing step, a temperature of the second enzyme oat-water mixture between 75^{o}C and 95^{o}C, inclusively. The method further includes cooling the second enzyme oat-water mixture to a temperature between 60^{o}C and 70^{o}C, inclusively. The method further includes adding a third enzyme blend to the second enzyme oat-water mixture to form a third enzyme oat-water mixture between 60^{o}C and 70^{o}, inclusively. The method further includes maintaining in a process step, a temperature of the third enzyme oat-water mixture between 60^{o}C and 70^{o}C, inclusively. The method further includes cooling the third enzyme oat-water mixture to between 50^{o}C and 60^{o}C, inclusively. The method further includes adding a fourth enzyme blend to the third enzyme oat-water mixture between 50^{o}C and 60^{o}C, inclusively, to form a fourth enzyme oat-water. The method further includes maintaining in a process step, a temperature of the fourth oat-water mixture between 50^{o}C and 60^{o}C, inclusively. The method further includes removing an amount of solids from the fourth enzyme oat-water mixture to form the oat composition.

In another embodiment, a method of making an oat composition is provided. The method includes adding oat flour to water to form an oat-water mixture. The method further includes adding a first enzyme blend to the oat-water mixture to form a first enzyme oat-water mixture. The method further includes increasing the temperature of the first enzyme oat-water mixture to between 60^{o}C and 70⁰C, inclusively. The method further includes adding a second enzyme blend to the first enzyme oat-mixture after increasing the temperature of the first enzyme oat-water mixture to between 60⁰C and 70^{o}C, inclusively, to form a second enzyme oat-water mixture. The method further includes a processing step, a temperature of the second enzyme oat-water mixture between 60⁰ and 70^{o}C, inclusively. The method further includes cooling the second enzyme oat-water mixture to a temperature between 50^{o}C and 60⁰C, inclusively. The method further includes adding a third enzyme blend to the second enzyme oat-water mixture to form a third enzyme oat-water mixture. The method further includes maintaining a temperature of the third enzyme oat-water mixture between 50⁰C and 60^{o}C inclusively. The method further includes removing an amount of solids from the third enzyme oat-water mixture to form the oat composition.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a flowchart of an embodiment of a process overview of manufacturing an oat-based beverage and food composition.

FIG. 2 illustrates a flowchart of another embodiment of a method of manufacturing an oat-based beverage and food composition.

FIG. 3 illustrates a flowchart of an embodiment downstream process for a product that includes an oat-based beverage and food composition.

FIG. 4 illustrates a flowchart of another embodiment of a method of manufacturing an oat-based beverage and food composition.

FIG. 5 illustrates a flowchart of a further embodiment of a method of manufacturing an oat-based beverage and food composition.

### DETAILED DESCRIPTION

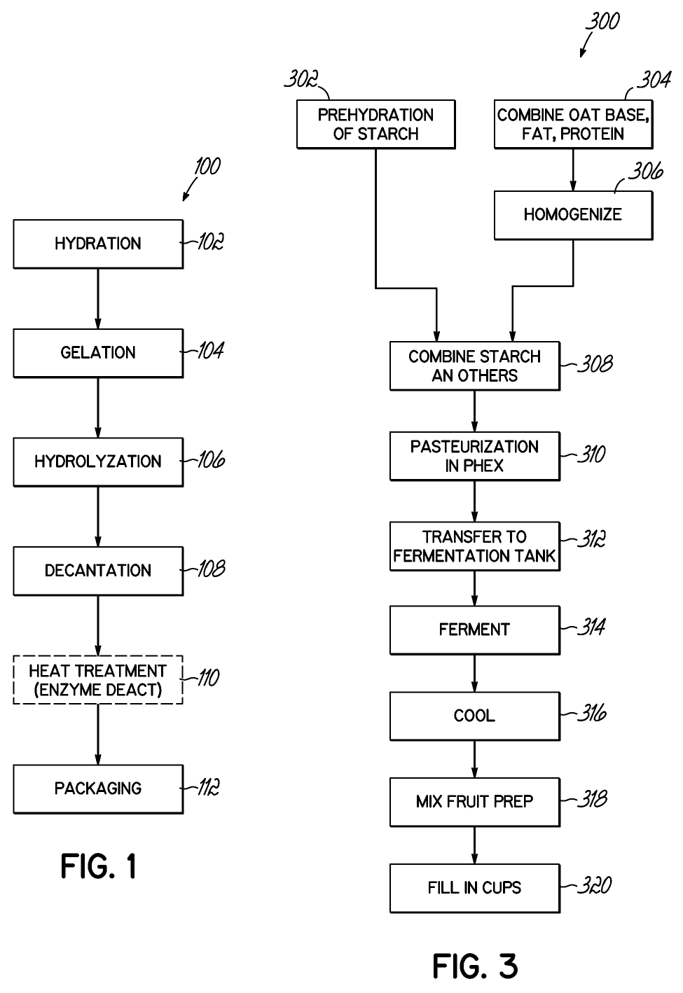

By way of a broad overview, a method 100 of manufacturing an oat composition is described herein (including several specific embodiments of such methods). FIG. 1 is a flowchart of an embodiment of a generalized process overview of manufacturing an oat-based beverage and food composition. The method 100 includes hydrating, in a step 102, oat flour or whole oat flour with water to form an oat-water mixture, as well as adding a first enzyme blend to the oat-water mixture to form a first enzyme oat-water mixture. The method 100 further includes gelatinizing, in a step 104, the first enzyme oat-water mixture by increasing the temperature of the first enzyme oat-water mixture and adding an additional amount of the first enzyme blend to the first enzyme oat-water mixture to form a second enzyme oat-water mixture. The method 100 further includes hydrolyzing, in a step 106, the second enzyme oat-water mixture by reducing the temperature of the second enzyme oat-water mixture and adding a second enzyme blend to the second enzyme oat-water mixture to form a third enzyme oat-water mixture. The method 100 further includes, in a step 108, decanting the third enzyme oat-water mixture to remove a fraction of insoluble solids of a particle size greater than or equal to 75 microns from the third enzyme oat-water mixture to form an oat composition. The method 100 further includes heating, in an optional step 110, the oat composition to deactivate the first enzyme blend and the second enzyme blend still present in the oat composition. The method 100 may further include, in a step 112, packaging the oat composition in a container.

The methods and steps of FIG. 1 will now be described in more detail. In some embodiments, the oat-water mixture is formed in the step 102 by adding water to oat flour or whole-oat flour. The amount of water added to the oat flour or whole oat flour is between about 70 wt% and about 90 wt%, inclusively, of the oat-water mixture. The amount of oat flour or whole oat flour used in the step 102 is between about 10 wt% and about 30 wt%, inclusively, of the oat-water mixture. The oat flour may be whole oat flour. In some embodiments, the temperature of the oat-water mixture is between about 10^{o}C and about 30^{o}C, inclusively. Preferably, the temperature of the oat-water mixture is between about 11^{o}C and about 29^{o}C, inclusively.

The step 102 may further include adding a first enzyme blend to the oat-water mixture to form a first enzyme oat-water mixture. The first enzyme blend is added to the oat-water mixture when the oat-water mixture is at a temperature of between about 10^{o}C and about 30^{o}C, inclusively. Preferably, the first enzyme blend is added to the oat-water mixture when the temperature of the oat-water mixture is between about 11^{o}C and about 29^{o}C, inclusively. The first enzyme blend acts to reduce the viscosity of the oat-water mixture during subsequent steps. In this way, the first enzyme oat-water mixture has a lower viscosity than the oat-water mixture. The enzyme(s) in the first enzyme blend also act to increase oat protein solubilization. In one embodiment, the first enzyme blend includes bacterial α-amylase, bacterial β-amylase, bacterial glucoamylase, fungal α-amylase, fungal β-amylase, fungal glucoamylase, protein deamidase, or mixtures thereof.

Throughout this specification, the terms “enzyme” and “enzyme blend” may be used interchangeably. By “enzyme blend,” it is meant that at least one enzyme (and possibly only one enzyme), or alternatively, combinations and mixtures of multiple enzymes may be used at these specific process steps, without departing from the scope of the present invention. Several specific examples are provided in the embodiments below, some of which having “enzyme blends” with just one enzyme and other “enzyme blends” being a combination of 2, 3, or more enzymes together to perform desired processing steps on the mixtures.

The method 100 further includes a step 104 in which gelation of the first enzyme oat-water mixture occurs. The step 104 includes increasing the temperature of the first enzyme oat-water mixture to between about 55^{o}C and about 75^{o}C. The step 104 further includes adding an additional amount of first enzyme blend to the first enzyme oat-water mixture to form a second enzyme oat-water mixture. In some embodiments, the additional amount of first enzyme blend may be added to the first enzyme oat-water mixture after the temperature increase of the first enzyme oat-water mixture. In some embodiments, the temperature of the second enzyme oat-water mixture is maintained between about 55^{o}C and about 75^{o}C for an amount of time, for example, between about 1 minute and about 60 minutes, inclusively. Maintaining the temperature between about 55^{o}C and about 75^{o}C for the amount of time encourages gelation of the oat-water first and second enzyme mixture.

The method 100 further includes a step 106 in which hydrolysis of the second enzyme oat-water mixture occurs. The temperature of the second enzyme oat-water mixture is reduced to between about 45^{o}C and about 65^{o}C, inclusively. In addition, in step 106, a second enzyme blend is added, in an amount between 0.025% and 3.5% by weight of the second enzyme oat-water mixture, to the second enzyme oat-water mixture to form a third enzyme oat-water mixture. The second enzyme blend is added to the second enzyme oat-water mixture after the second enzyme oat-water mixture has had its temperature become between about 45^{o}C and about 65^{o}C, inclusively. The enzymes added to the second enzyme oat-water mixture include enzymes that perform sensory functions as well as viscosity reduction and enzyme efficiency functions. In some embodiments, the enzymes included in the second enzyme blend may include bacterial α-amylase, fungal α-amylase, bacterial β-amylase, fungal β-amylase, bacterial glucoamylase, fungal glucoamylase, bacterial glucose oxidase, fungal glucose oxidase, bacterial catalase, fungal catalase, bacterial cellulase, fungal cellulase, or mixtures thereof. The enzymes included in the second enzyme blend help with breaking down starch and/or fiber into smaller units of carbohydrates and break the fibers into smaller units of fibers so as to convert the second enzyme oat-water mixture into a flowable liquid composition that can be then processed into a finished product. The enzymes included in the second enzyme blend also help convert sugars into their respective acids or salts. In some embodiments, the bacterial α-amylase, fungal α-amylase, or mixture thereof, performs a viscosity reduction function as well as an enzyme efficiency function. In this way, the third enzyme oat-water mixture has a lower viscosity than the second enzyme oat-water mixture and smaller sub-units of starch and fiber. Alternatively, or in addition, the β-amylase and the glucoamylase have viscosity reduction function, a sensory function, or both, to improve taste, mouthfeel, and over all sensorial experience of the enzyme oat-water mixture. The addition of the enzymes individually or in combination helps in reducing the intrinsic grain flavor of the oat and converts the intrinsic grain flavor of the oat into a more aromatic and appeasing sweet cereal flavor desired for the enzyme oat water mixture. At step 106, the temperature of the third enzyme oat-water mixture is maintained at between about 45^{o}C and about 65^{o}C, inclusively, to allow the second enzyme blend in the third enzyme oat-water mixture to hydrolyze the third enzyme oat-water mixture. Hydrolyses at step 106 may last from about 60 minutes to about 120 minutes.

The method 100 further includes separating solids from the third enzyme oat-water mixture in a step 108. Separating of solids from the third enzyme oat-water mixture may occur by decantation, clarification, centrifugation, or other separation process. In step 108, solids are separated and removed from the third enzyme oat-water mixture to leaving an oat composition with particle size less than or equal to 75 microns. The solids removed from the third enzyme oat-water mixture may include insoluble fibers or other solids that may have formed during the previous steps. In some embodiments, the third enzyme oat-water mixture is centrifuged to clarify the solid particulate in the third enzyme oat-water mixture from the liquid. An amount of the solids included in the third enzyme oat-water mixture is removed at step 108, resulting in the oat composition. The third enzyme oat-water mixture has a solids content of between about 20 wt% and about 30 wt%, inclusively, prior to removal of the amount of solids content. Preferably, in some embodiments, the third enzyme oat-water mixture has a solids content of between about 23 wt% and about 28 wt%, inclusively, of the third enzyme oat-water mixture. The oat composition has a solids content between about 15 wt% and about 29 wt%, inclusively. Preferably, the oat composition has a solids content between about 19 wt% and about 25 wt%.

In some embodiments, the method 100 further includes the optional step of deactivating, in a step 110, the various enzymes in the oat composition. To deactivate the enzymes, the oat composition is heated to between about 140^{o}C and 145⁰C, inclusively, and maintained at between 140^{o}C and 145⁰C, inclusively for between about 4 seconds and 9 seconds, inclusively. Note that this heating step to deactivate the enzyme(s) is not required in all embodiments and therefore can selectively be omitted to enhance the process efficiency.

In some embodiments, and as shown in FIG. 1, the method 100 may further include packaging, in a step 112, the oat composition. The oat composition may be packaged in cups having a volume of between 5.3 oz and 24 oz, inclusively, or other containers having a capacity of between, for example, 50 kg and 2000 kg, which may be suitable for carrying the oat composition.

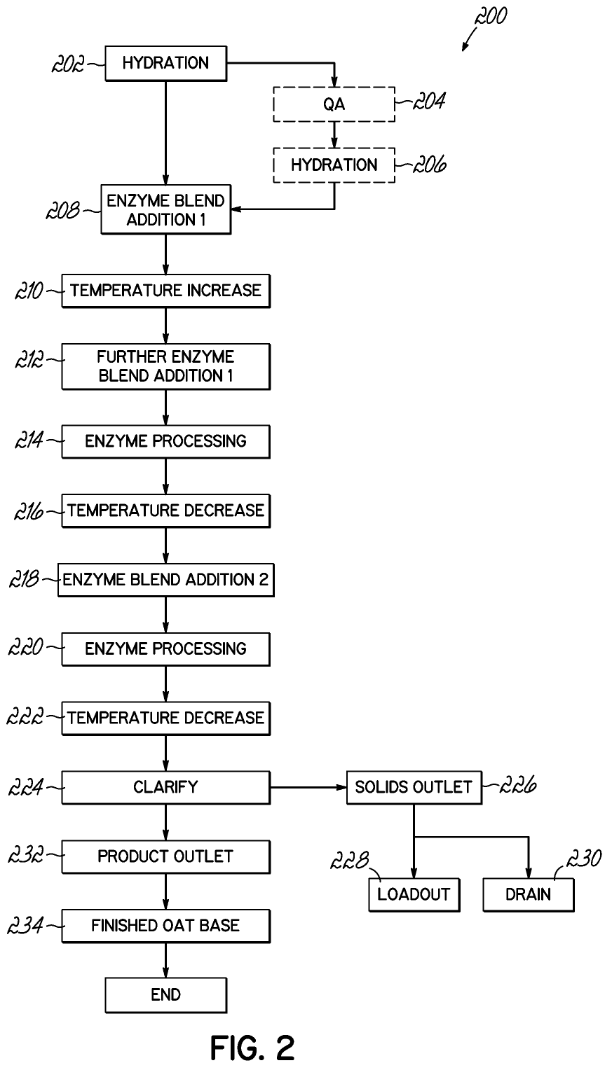

By way of an overview of a more detailed process, a method 200 of manufacturing an oat composition is described herein. FIG. 2 illustrates a flowchart of an embodiment of a manufacturing method 200 for an oat-based food composition. The method 200 includes adding oat flour, whole oat flour containing the germ, bran, husk of oat, or mixtures thereof, to water to form an oat-water mixture at step 202. The method further includes, at step 208, adding a first enzyme blend between 0.02% and 3 %, inclusively, by weight, to the oat-water mixture to form a first enzyme oat-water mixture. The method 200 further includes increasing, at step 210, the temperature of the first enzyme oat-water mixture and adding, at step 212, an additional amount of the first enzyme blend to the first enzyme oat-water mixture after the step 210 to form a second enzyme oat-water mixture. The method 200 further includes a step 214 which may include enzyme processing and include maintaining the temperature of the second enzyme oat-water mixture to allow for the first enzyme blend to further activate. The method 200 further includes cooling, at step 216, the second enzyme oat-water mixture. The method 200 further includes at step 218, adding a second enzyme blend to the second enzyme oat-water mixture to form a third enzyme oat-water mixture, and an enzyme processing step 220, which may include maintaining a temperature of the third enzyme oat-water mixture to allow for the second enzyme blend to process the third enzyme oat-water mixture. The method 200 further includes decreasing, at step 222, the temperature of the third enzyme oat-water mixture. The method 200 further includes clarifying, at step 224, the third enzyme oat-water mixture, which may include separating an amount of solids from the third enzyme oat-water mixture forming, at step 232, the oat composition. The amount of solids separated, at step 226, from the third enzyme oat-water mixture may be drained, at step 230, and discarded or reused in a loadout, at step 228. The oat composition, thus formed, at step 232, from having the amount of solids separated from the third enzyme oat-water mixture may then be finished further to form a finished oat base. The method 200 is able to yield between about 85 wt% and 90 wt% of the material used in the method 200. Such high yields are unusual in the industry. Alternatively or in addition, the method 200 is able to yield between about 85 wt% and 90 wt% of a sum of the weights of the water, oat flour or whole out flour, first enzyme blend, and second enzyme blend used in the method 200. Further, oat-based food compositions prepared by method 200 have increased stability during storage and shelf-life of the oat-based food composition compared to conventional oat-based food compositions. In addition, the method 200 is able to produce less waste than conventional methods of manufacturing oat-based food compositions.

The method 200 for manufacturing the oat composition may be a batch method. Alternatively, the method 200 for manufacturing the oat-based food composition may be a continuous or semi-continuous method. In embodiments where a batch method is used, the batch size may be between about 1800 gallons and about 5400 gallons, inclusively (between about 6.8 kL and 20 kL, inclusively). In some embodiments, the batch size may be selected from a group consisting of about 1800 gallons, about 2400 gallons, about 4200 gallons, about 4800 gallons, and about 5400 gallons (selected from the group consisting of about 6.8 kL, about 9 kL, about 15.9 kL, about 18.2 kL, and about 20kL). The batch process may use only a single tank or a plurality of connected tanks. Alternatively, the batch process may use a plurality or nonconnected tanks.

The method 200 and steps of FIG. 2 will now be described in further detail. In some embodiments, the oat-water mixture may be formed in a hydration step, at step 202, by adding water and oat flour or whole oat flour to a liquefier or tank. The method 200 includes, in the step 202, hydrating oat flour by adding oat flour to water, in a tank for example, to form an oat-water mixture. The oat flour may be whole oat flour. The water may be present in an amount between about 70 wt% and about 80 wt% of the oat-water mixture. The balance of the weight of the oat-water mixture is oat flour or whole oat flour. Alternatively or in addition, the oat flour or whole oat flour may be present in an amount between about 20 wt% to about 30 wt% in the oat-water mixture. In some embodiments, the oat-water mixture includes about 75 wt% of water and 25 wt% oat flour or whole oat flour. In some embodiments, the temperature of the oat-water mixture is between about 20^{o}C and about 30^{o}C, inclusively. Preferably, the temperature of the oat-water mixture is between about 10^{o}C and about 25^{o}C, inclusively. A step 204 may be a quality assurance step of the oat-water mixture, and may be conducted to assure that the pH and solids weight percentage of the oat-water mixture is within specification. For example, the step 204 may be a step to assure that the pH of the oat-water mixture is between 6.5 and 7.5, inclusively. Alternatively, or in addition, in another example, the step 204 may be a step in assure that the solids weight percentage of the oat-water mixture is between 24% and 29%, inclusively. In some embodiments, corrective measures, such as additional hydration at step 206, which may include adding additional water, oat flour, whole oat flour, or mixtures thereof, to the oat-water mixture to bring the pH and solids weight percentage of the oat-water mixture into specification may occur. Quality assurance at step 204 are not limited to occurring only after hydration at step 202, but is included here merely as a non-limiting example. Quality assurance measures at step 204 may occur after any or all of the steps included in the method 200, and may include a variety of correction steps, such as hydration at step 206. The corrective step is not limited to hydration at step 206, but may alternatively or in addition, in a non-limiting list, include separating solids, increasing or decreasing temperature, adding enzymes, adding oat flour, or allowing for additional time for enzyme activation. Each of these steps is accomplished while the oat-water enzyme mixture maintains a pH between 6.5 and 7.2, inclusively.

The method 200 further includes adding a first enzyme blend at step 208 to the oat-water mixture to form a first enzyme oat-water mixture. The first enzyme blend is added to the oat-water mixture when the oat-water mixture is at a temperature of between about 10^{o}C and about 30^{o}C, inclusively. Alternatively, the first enzyme blend is added to the oat-water mixture when the temperature of the oat-water mixture is between about 10^{o}C and about 25^{o}C, inclusively. The first enzyme blend acts to reduce the viscosity of the oat-water mixture during subsequent steps. In this way, the first enzyme oat-water mixture has a lower viscosity than the oat-water mixture. In one embodiment, the first enzyme blend includes bacterial α-amylase, fungal α-amylase, bacterial β-amylase, fungal β-amylase, bacterial glucose oxidase, fungal glucose oxidase, other peroxidases, protein deamidase, or mixtures thereof.

The method 200 further includes increasing the temperature at step 210 of the first enzyme oat-water mixture. As mentioned above, the temperature of the first enzyme oat-water mixture may originally be between about 10^{o}C and about 30^{o}C, inclusively. The temperature of the first enzyme oat-water mixture is increased at step 210 to be between about 70^{o}C and about 90^{o}C, inclusively. In some embodiments, the temperature of the first enzyme oat-water mixture is increased to between about 75^{o}C and 85^{o}C, inclusively.

The method 200 further includes adding an additional amount of the first enzyme blend at step 212 to the first enzyme oat-water mixture to form the second enzyme oat-water mixture. The additional amount of the first enzyme blend at step 212 is added after the temperature of the first enzyme oat-water mixture is increased in temperature at step 210, when the first enzyme oat-water mixture has a temperature of between about 70^{o}C and about 90^{o}C, or preferably, when the first enzyme oat-water mixture has a temperature of between about 75^{o}C and about 85^{o}C. At least because the temperature of the first enzyme oat-water mixture has already been increased, the additional amount of first enzyme blend added to the first enzyme oat-water mixture is activated soon after its addition and formation of the second enzyme oat-water mixture.

The method 200 further includes a processing step at step 214 to allow the first enzyme blend in the second enzyme oat-water mixture to activate and process the second enzyme oat-water mixture. The processing step at step 214 may last from about 1 minute to about 20 minutes. Preferably, the processing step at step 214 occurs for about 5 minutes to about 15 minutes. Even more preferably, the processing step at step 214 occurs for about 10 minutes. During the processing step at step 214, the temperature of the second enzyme oat-water mixture is maintained at between about 70^{o}C and about 90^{o}C, inclusively. Alternatively, during the processing step at step 214, the temperature of the second enzyme oat-water mixture is maintained between about 75^{o}C and about 85^{o}C, inclusively.

The method 200 further includes a temperature decreasing step at step 216. During the temperature decreasing step at step 216, the temperature of the second enzyme oat-water mixture is reduced to between about 50^{o}C and about 70^{o}C, inclusively. The temperature decreasing step at step 216 is done in preparation of the addition of a second enzyme blend into the second enzyme oat-water mixture.

The method 200 further includes adding the second enzyme blend between 0.02% – 3% by weight to the blend at step 218 to the second enzyme oat-water mixture to form a third enzyme oat-water mixture, and an enzyme processing step at step 220. The second enzyme blend is added to the second enzyme oat-water mixture after the second enzyme oat-water mixture has had its temperature become between about 50^{o}C and about 70^{o}C, inclusively. The second enzyme blend added to the second enzyme oat-water mixture include enzymes that perform sensory functions as well as viscosity reduction and enzyme efficiency functions. In some embodiments, the enzymes included in the second enzyme blend may include a bacterial α-amylase, a fungal α-amylase, a bacterial β-amylase, a fungal β-amylase, a bacterial glucoamylase, a fungal glucoamylase, a bacterial glucose oxidase, a fungal glucose oxidase, other peroxidase enzymes, or mixtures thereof. In some embodiments, the bacterial α-amylase, fungal α-amylase, bacterial β-amylase, or fungal β-amylase performs a viscosity reduction function as well as an enzyme efficiency function. In this way, the third enzyme oat-water mixture has a lower viscosity than the second enzyme oat-water mixture. Alternatively or in addition, the β-amylase and the glucoamylase have sensory functions and improve the mouthfeel of the oat-water enzyme blend. Individually and in combination, the enzymes added to the second enzyme oat-water mixture help improve taste, mouthfeel and over all sensorial experience of the enzyme oat-water mixture.

The method 200 further includes a processing step at step 220 to allow the second enzyme blend in the third enzyme oat-water mixture to activate and process the third enzyme oat-water mixture. The processing step at step 220 may last from about 1 minute to about 60 minutes. Preferably, the processing step at step 220 occurs for about 20 minutes to about 50 minutes. Even more preferably, the processing step at step 220 occurs for about 45 minutes. During the processing step at step 220, the temperature of the third enzyme oat-water mixture is maintained at between about 50^{o}C and about 60^{o}C, inclusively.

Optionally, method 200 further includes a temperature decreasing step at step 222. During the temperature decreasing step at step 222, the temperature of the third enzyme oat-water mixture is reduced to about between 40^{o}C and about 60^{o}C, inclusively. Preferably, the temperature of the third enzyme oat-water mixture is reduced to between about 40^{o}C and about 50^{o}C. Even more preferably, the temperature of the third enzyme oat-water mixture is adjusted to be about 47^{o}C. The temperature decreasing step at step 222 is done to facilitate the separation of solids from the third enzyme oat-water mixture. The temperature decreasing step at step 222 is also done to reduce losses of solids that would occur during separation at higher temperatures.

The method 200 further includes a clarifying step at step 224. During the clarifying step, the third enzyme oat-water mixture is centrifuged to clarify the solid particulate in the third enzyme oat-water mixture from the liquid. An amount of the solids included in the third enzyme oat-water mixture is removed at step 226, either during the clarification step at step 224 or after the clarification step at step 224, resulting in the oat composition. The third enzyme oat-water mixture has a solids content of between about 20 wt% and about 30 wt%, inclusively, prior to removal of the amount of solids content. Preferably, in some embodiments, the third enzyme oat-water mixture has a solids content of between about 23.5 wt% and about 25 wt%, inclusively, of the third enzyme oat-water mixture. During the clarification step at step 224 or after the clarification step at step 224, an amount of solids from the third enzyme oat-water mixture is removed at step 226 from the third enzyme oat-water mixture resulting in the oat composition. The oat composition has a solids content between about 15 wt% and about 25 wt%, inclusively. Preferably, the oat composition has a solids content between about 20.5 wt% and about 22 wt%.

The solids removed from the third enzyme oat-water mixture may either be collected in a loadout step at step 228 or may be drained at step 230 from the system. The loadout step at step 228 may include collecting the solids removed from the third enzyme oat-water mixture may be used in a recycle step, sold, destroyed, or used in other processes. The solids removed from the third enzyme oat-water mixture may alternatively or in addition to the loadout step at step 228, be drained at step 230 from the system and discarded as waste.

The method 200 further includes a product outlet step at step 232. The product outlet step at step 232 includes the oat composition. As mentioned above, the oat composition has a solids content between about 15 wt% and about 25 wt%, inclusively. Preferably, the oat composition has a solids content between about 20.5 wt% and about 22 wt%. The method 200 is able to yield between about 85 wt% and 90 wt% of the material used in the method 200. Such high yields are unusual in the industry. Alternatively or in addition, the method 200 is able to yield between about 85 wt% and 90 wt% of a sum of the weights of the water, oat flour or whole out flour, first enzyme blend, and second enzyme blend used in the method 200. These yields are able to be achieved from the unique blend of enzymes used in the manufacturing method 200 as well as the temperature and pH controls.

The method 200 further includes a finished oat base step at step 234. The finished oat base step at step 234 includes using the oat composition for either making oat beverages, making fermented cups, or selling the oat composition as a commodity.

At least because the oat-based food composition is oat-based and not milk-based, the carbohydrates included in the oat-based food composition may include glucose and maltose, but the oat-based food composition is substantially free of lactose. In addition, at least because the oat-based food composition has undergone the method of manufacture described in the preceding paragraphs, the oat-based food composition has an increased shelf stability compared to conventional oat-based food compositions.

The method 200 optionally includes a quality assurance step, at step 204, to check, for example, temperature, pH, and solids content levels, and corrective measures, at step 206, may be taken if these, or other, parameters are outside of specification to put these, or other, parameters back into specification. If the temperature, pH, solids content levels are not to specification within any portion of the process, the desired functionality of the oat base and finished products may be detrimentally affected.

In some embodiments, a portion of the oat composition may be used in a recycle step and fed into a new batch for manufacturing the oat composition.

A particular, non-limiting embodiment of the oat composition is now discussed. In the particular embodiment, the oat composition includes water at an amount between about 54 wt% and about 55 wt%. In the particular embodiment, the oat composition further includes the oat-water mixture, discussed above and produced in the hydration step 202, in an amount between about 21 wt% and about 23 wt%. In the particular embodiment, the oat composition further includes food starch in an amount between about 3.2 wt% and about 3.5 wt%. In the particular embodiment, the oat composition further includes vegetable fat in an amount between about 2.9 wt% and about 3.55 wt%. In the particular embodiment, the oat composition further includes vegetable protein in an amount between about 4.75 wt% and about 5.4 wt%. In the particular embodiment, the oat composition further includes natural flavor additives in an amount between about 0.05 wt% and about 0.15 wt%. In the particular embodiment, the oat composition further includes fruit in an amount between about 10 wt% and about 12 wt%. In the particular embodiment, the oat composition further includes hydrocolloids in an amount between about 0.35 wt% and about 0.39 wt%. In the particular embodiment, the oat composition further includes citric acid in an amount between about 0.05 wt% and about 0.71 wt%. All of these ranges are inclusive of the endpoints. Though the word “about” is used to identify the endpoints of these ranges, the precise endpoint values are also contemplated to be used.

Further, as described above, the oat composition may be used in an oat beverage. A particular embodiment of the oat beverage is now discussed. In the particular embodiment, the oat beverage includes water in an amount between about 64.5 wt% and about 66 wt%. The particular embodiment of the oat beverage further includes the oat-water mixture discussed above and produced in the hydration step 202, in an amount between about 31 wt% and about 33 wt%. The particular embodiment of the oat beverage further includes vegetable oil in an amount between about 1.69 wt% and about 1.96 wt%. The particular embodiment of the oat beverage further includes dipotassium phosphate in an amount between about 0.32 wt% and about 0.40 wt%. The particular embodiment of the oat beverage further includes calcium carbonate in an amount between about 0.24 wt% and about 0.32 wt%. The particular embodiment of the oat beverage further includes tricalcium phosphate in an amount between about 0.09 wt% and about 0.12 wt %. The particular embodiment of the oat beverage further includes hydrocolloid in an amount between about 0.03 wt% and about 0.04 wt%. The particular embodiment of the oat beverage further includes sea salt in an amount between about 0.1 wt% and about 0.12 wt%. The particular embodiment of the oat beverage further includes other vitamins and minerals in an amount between about 0.03 wt% and about 0.04 wt%.

FIG. 3 is a flowchart of an embodiment downstream process including a method 300 for manufacturing a product that includes an oat-based food composition. The method 300 includes pre-hydration of starch in a step 302. The method 300 further includes combining an oat base, fat, and protein in a step 304. The method 300 further includes homogenizing the oat base, fat, and protein in a step 306. The method 300 further includes, in a step 308, combining starch and the homogenized oat base, fat, and protein. The method 300 further includes pasteurizing, in a step 310, the homogenized oat base, fat, and protein combined with the starch. The method 300 further includes transferring the pasteurized, homogenized oat base, fat, and protein combined with the starch, in a step 312, to a fermentation tank. The method 300 further includes fermenting, in a step 314, the pasteurized, homogenized oat base, fat, and protein combined with the starch. The method 300 further includes, in a step 316, cooling the fermented, pasteurized, homogenized oat base, fat, and protein combined with the starch. In some embodiments, the method 300 further includes adding, in a step 318, an additive to the fermented, pasteurized, homogenized oat base, fat, and protein combined with the starch. The method 300 further includes filling, in a step 320, a container with the fermented, pasteurized, homogenized oat base, fat, and protein combined with the starch, along with, in some embodiments, the additive.

The method 300 includes the pre-hydration of starch at step 302. The pre-hydration of starch includes adding water to a starch. The starch may include starch from oat, wheat, tapioca, corn, or several of these, to form a water-starch mixture. The water-starch mixture may include water in an amount between about 70 wt% and 80 wt%. The water-starch mixture may further include the starch in an amount between about 20 wt% and about 30 wt%. The pre-hydration step at step 302 allows for the unfolding of the starch molecules so that the starch molecules are available for reaction with the enzyme. The pre-hydration step at step 302 also activates some of the natural enzymes that are present in the starch flour that function to modify the starch by, for example, reducing the long starch to shorter sub units. The water-starch mixture may be maintained at between 5^{o}C and 70^{o}C, preferably about 60^{o}C, for about 5 minutes to allow the starch to be properly hydrated.

The method 300 further includes, in a step 304, combining the oat composition with a fat composition and a protein. The fat composition may be present in an amount of 0.5% to 4%, inclusively, by weight of the combined oat base, fat composition, and protein, and may include canola, medium chain triglycerides, oil from coconut, oil from sunflower, algal oil, other plant-based oils, or combinations thereof. The protein may be present in an amount of between 0.5% and 7%, inclusively, by weight of the combined oat base, fat composition, and protein, and may include pea, sunflower, hemp, quinoa, soy, rice, white teff, oat, brown teff, canola, or combinations thereof. In step 304, the oat composition, which may be an oat composition as prepared in the previously described methods 100, 200, is combined with the fat composition and the protein at a temperature of between about 40^{o}C and 50^{o}C to form an oat-fat-protein mixture. In some examples, step 304 may include agitating the oat-fat-protein mixture to encourage sufficient mixing.

The method 300 further includes, in a step 306, homogenizing the oat-fat-protein mixture to form a homogenized oat-far-protein mixture. Homogenization in step 306 may occur at a pressure of between 1,400 psig and 4,500 psig, inclusively, and between about 40^{o}C and 50^{o}C, inclusively to make a stable emulsion of the oat-fat-protein mixture.

The method 300 further includes, in a step 308, combining the water-starch mixture with the homogenized oat-fat-protein mixture to form a starch-oat mixture. In some examples, the water-starch mixture is combined with the homogenized oat-fat-protein mixture by blending them together to form a stable oil in water emulsion.

The method 300 further includes, in a step 310, pasteurizing the starch oat-mixture to form a pasteurized starch-oat mixture. During pasteurization, the starch-oat mixture is sterilized to reduce a risk of food poisoning. The pasteurization in the step 310, may occur at a temperature of between about 77^{o}C and 97⁰C, inclusively, for a duration, which may be between about 3 seconds and 10 minutes. After the duration, the pasteurized starch-oat mixture is cooled to about 37.8^{o}C in a plate heat exchanger.

The method 300 further includes, in a step 312, transferring the pasteurized starch-oat mixture to a fermentation tank with the use of centrifugal pumps in less than 90 minutes.

The method 300 further includes, in a step 314, fermenting the pasteurized starch-oat mixture in the fermentation tank to form a fermented starch-oat mixture. During step 314, fermentation of the pasteurized starch-oat mixture occurs During fermentation of portions of the pasteurized starch-oat are fermented by lactic acid bacteria that convert the sugars in the mixture into organic acids and the protein in the mixture into smaller peptides. The fermentation process occurs at a temperature of about 37.8^{o}C and occurs over a duration, which may be between about 5 hours and about 8 hours, inclusively.

The method 300 further includes, in a step 316, cooling the fermented starch-oat mixture. In step 316, the fermented starch-oat mixture is cooled to between about 18 ⁰C and 21.1^{o}C, inclusively.

The method 300 further includes, in a step 318, adding an additive to the starch-oat mixture to form an oat-based food product. The additive may include fruit, artificial or natural flavoring, food coloring dyes, salt, sea salt, vitamins, minerals, oils such as vegetable oil, fats such as vegetable fats, protein such as vegetable protein, calcium carbonate, citric acid, hydrocolloids, dipotassium phosphate, tricalcium phosphate, or other additives. In embodiments where fruit is added, the fruit may be mixed, blended, or otherwise incorporated into the fermented starch-oat mixture. In an embodiment where fruit is added, the fruit may be about 10 wt% of the fermented starch-oat mixture.

The method 300 may further include, in a step 320 and as shown in FIG. 3, packaging the oat-based food product. The oat-based food product may be packaged in step 320 in cups or other containers suitable for carrying the oat composition. The cups may have a volume of about 5.3 oz. The oat-based food product may also be packaged in an array of different size containers including up to 52 oz.

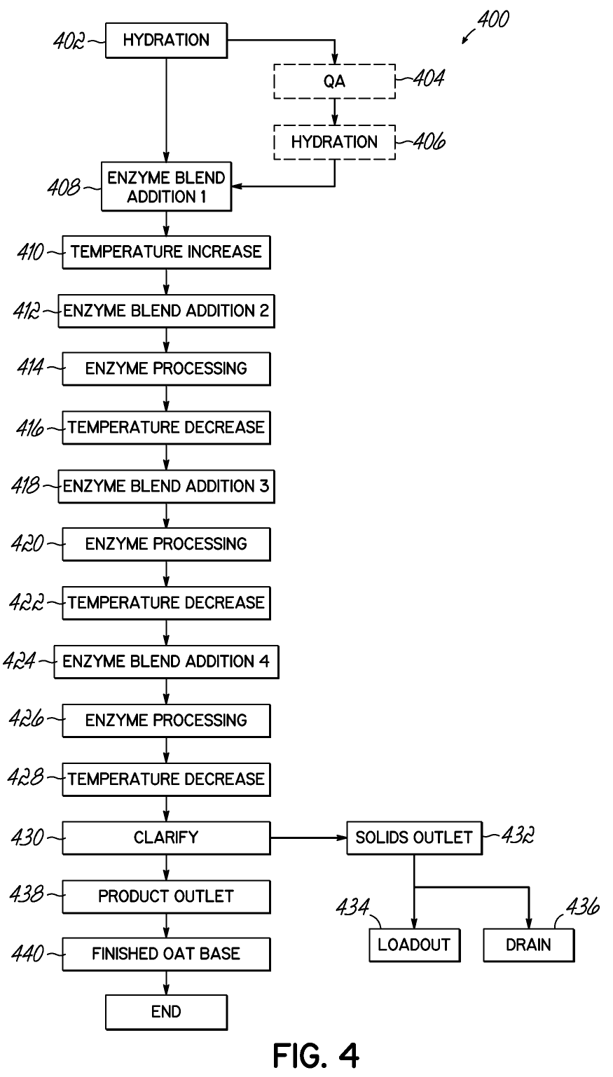

A flowchart of another embodiment in FIG. 4 includes a method 400 of manufacturing an oat-based food composition. The method 400 includes adding oat flour, whole oat flour containing the germ, bran, husk of oat, or mixtures thereof, to water to form an oat-mixture at step 402. The method further includes, at step 408, adding a first enzyme blend between 0.02% and 3% inclusively, by weight, to the oat-water mixture to form a first enzyme oat-water mixture. The method 400 further includes increasing, at step 410, the temperature of the first enzyme oat-water

mixture and adding, at step 412, a second enzyme blend to the first enzyme oat-water mixture after the step 410 to form a second enzyme oat-water mixture. The method 400 further includes a step 414 which may include enzyme processing and include maintaining the temperature of the second enzyme oat-water mixture to allow for the first enzyme blend to further activate. The method 400 further includes cooling, at step 416, the second enzyme oat-water mixture. The method 400 further includes at step 418, adding a third enzyme blend to the second enzyme oat-water mixture to form a third enzyme oat-water mixture, and an enzyme processing step 420, which may include maintaining a temperature of the third enzyme oat-water mixture to allow for the third enzyme blend to process the third enzyme oat-water mixture. The method 400 further includes decreasing, at step 422, the temperature of the third enzyme oat-water mixture. The method 400 further includes at step 424, adding a fourth enzyme blend to the third enzyme oat-water mixture to form a fourth enzyme oat-water mixture, and an enzyme processing step 426, which may include maintaining a temperature of the fourth enzyme oat-water mixture to allow for the fourth enzyme blend to process the fourth enzyme oat-water mixture. The method 400 further includes decreasing, at step 428, the temperature of the fourth enzyme oat-water mixture. The method 400 further includes clarifying, at step 430, the fourth enzyme oat-water mixture, which may include separating an amount of solids from the fourth enzyme oat-water mixture forming, at step 438/440, the oat composition. The amount of solids separated, at step 432, from the fourth enzyme oat-water mixture may be drained, at step 436, and discarded or reused in a loadout, at step 434. The oat composition, thus formed, at step 432, from having the amount of solids separated from the fourth enzyme oat-water mixture may then be finished further to form a finished oat base. The method 400 is able to yield between about 85 wt% and 90 wt% of the material used in the method 400. Such high yields are unusual in the industry. Alternatively, or in addition, the method 400 is able to yield between about 85 wt% and 90 wt% of a sum of the weights of the water, oat flour or whole out flour, first enzyme, and enzyme blend used in the method 400. Further, oat-based food compositions prepared by method 400 have increased stability during storage and shelf-life of the oat-based food composition compared to conventional oat-based food compositions. In addition, the method 400 is able to produce less waste than conventional methods of manufacturing oat-based food compositions.

The method 400 for manufacturing the oat composition may be a batch method. Alternatively, the method 400 for manufacturing the oat-based food composition may be a continuous or semi-continuous method. In embodiments where a batch method is used, the batch size may be between about 1800 gallons and about 5400 gallons, inclusively (between about 6.8 kL and 20 kL, inclusively). In some embodiments, the batch size may be selected from a group consisting of about 1800 gallons, about 2400 gallons, about 4200 gallons, about 4800 gallons, and about 5400 gallons (selected from the group consisting of about 6.8 kL, about 9 kL, about 15.9 kL, about 18.2 kL, and about 20kL). The batch process may use only a single tank or a plurality of connected tanks. Alternatively, the batch process may use a plurality or nonconnected tanks.

The method 400 and steps of FIG. 4 will now be described in further detail. In some embodiments, the oat-water mixture may be formed in a hydration step, at step 402, by adding water and oat flour or whole oat flour to a liquefier or tank. The method 400 includes, in the step 402, hydrating oat flour by adding oat flour to water, in a tank for example, to form an oat-water mixture. The oat flour may be whole oat flour. The water may be present in an amount between about 70 wt% and about 80 wt% of the oat-water mixture. The balance of the weight of the oat-water mixture is oat flour or whole oat flour. Alternatively, or in addition, the oat flour or whole oat flour may be present in an amount between about 20 wt% to about 30 wt% in the oat-water mixture. In some embodiments, the oat-water mixture includes about 75 wt% of water and 25 wt% oat flour or whole oat flour. In some embodiments, the temperature of the oat-water mixture is between about 20^{o}C and about 30^{o}C, inclusively. Preferably, the temperature of the oat-water mixture is between about 10^{o}C and about 25^{o}C, inclusively. A step 404 may be a quality assurance step of the oat-water mixture and may be conducted to assure that the pH and solids weight percentage of the oat-water mixture is within specification. For example, the step 404 may be a step to assure that the pH of the oat-water mixture is between 6.5 and 7.5, inclusively. Alternatively, or in addition, in another example, the step 204 may be a step in assure that the solids weight percentage of the oat-water mixture is between 24% and 29%, inclusively. In some embodiments, corrective measures, such as additional hydration at step 406, which may include adding additional water, oat flour, whole oat flour, or mixtures thereof, to the oat-water mixture to bring the pH and solids weight percentage of the oat-water mixture into specification may occur. Quality assurance at step 404 is not limited to occurring only after hydration at step 402 but is included here merely as a non-limiting example. Quality assurance measures at step 404 may occur after any or all of the steps included in the method 400, and may include a variety of correction steps, such as hydration at step 406. The corrective step is not limited to hydration at step 406, but may alternatively or in addition, in a non-limiting list, include separating solids, increasing or decreasing temperature, adding enzymes, adding oat flour, or allowing for additional time for enzyme activation. Each of these steps is accomplished while the oat-water enzyme mixture maintains a pH between 6.5 and 7.2, inclusively.

The method 400 further includes adding a first enzyme blend at step 408 to the oat-water mixture to form a first enzyme oat-water mixture. The first enzyme blend is added to the oat-water mixture when the oat-water mixture is at a temperature of between about 10^{o}C and about 30^{o}C, inclusively. Alternatively, the first enzyme blend is added to the oat-water mixture when the temperature of the oat-water mixture is between about 10^{o}C and about 25^{o}C, inclusively. The first enzyme blend acts to reduce the viscosity of the oat-water mixture during subsequent steps. In this way, the first enzyme oat-water mixture has a lower viscosity than the oat-water mixture. In one embodiment, the first enzyme blend may include bacterial α-amylase, fungal α-amylase, bacterial β-amylase, fungal β-amylase, bacterial glucose oxidase, fungal glucose oxidase, other peroxidases, protein deamidase, or mixtures thereof. Furthermore, the first enzyme blend and the second enzyme blend may be the same enzyme(s) in some embodiments, just added at different steps of the process.

The method 400 further includes increasing the temperature at step 410 of the first enzyme oat-water mixture. As mentioned above, the temperature of the first enzyme oat-water mixture may originally be between about 10^{o}C and about 30^{o}C, inclusively. The temperature of the first enzyme oat-water mixture is increased at step 410 to be between about 70^{o}C and about 95^{o}C, inclusively. In some embodiments, the temperature of the first enzyme oat-water mixture is increased to between about 75^{o}C and 95^{o}C, inclusively.

The method 400 further includes adding a second enzyme blend at step 412 to the first enzyme oat-water mixture to form the second enzyme oat-water mixture. The second enzyme blend at step 412 is added after the temperature of the first enzyme oat-water mixture is increased in temperature at step 410, when the first enzyme oat-water mixture has a temperature of between about 70^{o}C and about 95^{o}C, or preferably, when the first enzyme oat-water mixture has a temperature of between about 75^{o}C and about 95^{o}C. At least because the temperature of the first enzyme oat-water mixture has already been increased, the second enzyme blend added to the first enzyme oat-water mixture is activated soon after its addition and formation of the second enzyme oat-water mixture.

The method 400 further includes a processing step at step 414 to allow the first and second enzyme blends in the second enzyme oat-water mixture to activate and process the second enzyme oat-water mixture. The processing step at step 414 may last from about 1 minute to about 20 minutes. Preferably, the processing step at step 414 occurs for about 5 minutes to about 15 minutes. Even more preferably, the processing step at step 414 occurs for about 10 minutes. During the processing step at step 414, the temperature of the second enzyme oat-water mixture is maintained at between about 70^{o}C and about 95^{o}C, inclusively. Alternatively, during the processing step at step 414, the temperature of the second enzyme oat-water mixture is maintained between about 75^{o}C and about 95^{o}C, inclusively.

The method 400 further includes a temperature decreasing step at step 416. During the temperature decreasing step at step 416, the temperature of the second enzyme oat-water mixture is reduced to between about 60^{o}C and 70⁰C, inclusively. The temperature decreasing step at step 416 is done in preparation of the addition of a third enzyme blend into the second enzyme oat-water mixture.

The method 400 further includes adding a third enzyme blend between 0.02% – 3% by weight to the blend at step 418 to the second enzyme oat-water mixture to form a third enzyme oat-water mixture, and an enzyme processing step at step 420. The third enzyme blend is added to the second enzyme oat-water mixture after the second enzyme oat-water mixture has had its temperature become between about 60^{o}C and about 70^{o}C, inclusively. The third enzyme blend added to the second enzyme oat-water mixture include enzymes that perform sensory functions as well as viscosity reduction and enzyme efficiency functions. In one embodiment, the third enzyme blend is a protein glutaminase. In another embodiment, the third enzyme blend may include bacterial α-amylase, fungal α-amylase, bacterial β-amylase, fungal β-amylase, bacterial glucose oxidase, fungal glucose oxidase, other peroxidases, protein deamidase, or mixtures thereof In this way, the third enzyme oat-water mixture has a lower viscosity than the second enzyme oat-water mixture. Individually and in combination, the third enzyme blend added to the second enzyme oat-water mixture help improve taste, mouthfeel and over all sensorial experience of the enzyme oat-water mixture.

The method 400 further includes a processing step at step 420 to allow the third enzyme blend in the third enzyme oat-water mixture to activate and process the third enzyme oat-water mixture. The processing step at step 420 may last from about 1 minute to about 60 minutes. Preferably, the processing step at step 420 occurs for about 20 minutes to about 50 minutes. Even more preferably, the processing step at step 420 occurs for about 45 minutes to 60 minutes. During the processing step at step 420, the temperature of the third enzyme oat-water mixture is maintained at between about 60^{o}C and about 70^{o}C, inclusively.

Optionally, method 400 further includes a temperature decreasing step at step 422. During the temperature decreasing step at step 422, the temperature of the third enzyme oat-water mixture is reduced to about between 40^{o}C and about 60^{o}C, inclusively. Preferably, the temperature of the third enzyme oat-water mixture is reduced to between about 40^{o}C and about 50^{o}C. The temperature decreasing step at step 422 is done to facilitate the separation of solids from the third enzyme oat-water mixture. The temperature decreasing step at step 422 is also done to reduce losses of solids that would occur during separation at higher temperatures.

The method 400 further includes adding an fourth enzyme blend between 0.02% – 3% by weight at step 424 to the third enzyme oat-water mixture to form a fourth enzyme oat-water mixture, and an enzyme processing step at step 426. The fourth enzyme blend is added to the third enzyme oat-water mixture after the third enzyme oat-water mixture has had its temperature become between about 40^{o}C and about 60^{o}C, inclusively. The fourth enzyme blend added to the third enzyme oat-water mixture include enzymes that perform sensory functions as well as viscosity reduction and enzyme efficiency functions. In some embodiments, the enzymes include in the fourth enzyme blend may include a bacterial α-amylase, a fungal α-amylase, a bacterial β-amylase, a fungal β-amylase, a bacterial glucoamylase, a fungal glucoamylase, a bacterial glucose oxidase, a fungal glucose oxidase, other peroxidase enzymes, or mixtures thereof. In some embodiments, the bacterial α-amylase, fungal α-amylase, bacterial β-amylase, or fungal β-amylase performs a viscosity reduction function as well as an enzyme efficiency function. In this way, the fourth enzyme oat-water mixture has a lower viscosity than the second enzyme oat-water mixture. Alternatively, or in addition, the β-amylase and the glucoamylase have sensory functions and improve the mouthfeel of the oat-water enzyme blend. Individually and in combination, the enzymes added to the fourth enzyme oat-water mixture help improve taste, mouthfeel and over all sensorial experience of the enzyme oat-water mixture.

The method 400 further includes a processing step at step 426 to allow the fourth enzyme blend in the fourth enzyme oat-water mixture to activate and process the fourth enzyme oat-water mixture. The processing step at step 426 may last from about 1 minute to about 60 minutes. Preferably, the processing step at step 426 occurs for about 20 minutes to about 50 minutes. Even more preferably, the processing step at step 426 occurs for about 45 minutes. During the processing step at step 426, the temperature of the fourth enzyme oat-water mixture is maintained at between about 50^{o}C and about 60^{o}C, inclusively.

Optionally, method 400 further includes a temperature decreasing step at step 428. During the temperature decreasing step at step 428, the temperature of the fourth enzyme oat-water mixture is reduced to about between 40^{o}C and about 60^{o}C, inclusively. The temperature decreasing step at step 428 is done to facilitate the separation of solids from the third enzyme oat-water mixture. The temperature decreasing step at step 428 is also done to reduce losses of solids that would occur during separation at higher temperatures.

The method 400 further includes a clarifying step at step 430. During the clarifying step, the fourth enzyme oat-water mixture is centrifuged to clarify the solid particulate in the fourth enzyme oat-water mixture from the liquid. An amount of the solids included in the fourth enzyme oat-water mixture is removed at step 432, either during the clarification step at step 430 or after the clarification step at step 430, resulting in the oat composition. The fourth enzyme oat-water mixture has a solids content of between about 20 wt% and about 30 wt%, inclusively, prior to removal of the amount of solids content. Preferably, in some embodiments, the fourth enzyme oat-water mixture has a solids content of between about 23.5 wt% and about 25 wt%, inclusively, of the fourth enzyme oat-water mixture. During the clarification step at step 430 or after the clarification step at step 430, an amount of solids from the fourth enzyme oat-water mixture is removed at step 432 from the fourth enzyme oat-water mixture resulting in the oat composition. The oat composition has a solids content between about 15 wt% and about 25 wt%, inclusively. Preferably, the oat composition has a solids content between about 20.5 wt% and about 22 wt%.

The solids removed from the fourth enzyme oat-water mixture may either be collected in a loadout step at step 434 or may be drained at step 436 from the system. The loadout step at step 434 may include collecting the solids removed from the fourth enzyme oat-water mixture may be used in a recycle step, sold, destroyed, or used in other processes. The solids removed from the fourth enzyme oat-water mixture may alternatively or in addition to the loadout step at step 434, be drained at step 436 from the system and discarded as waste.

The method 400 further includes a product outlet step at step 438. The product outlet step at step 438 includes the oat composition. As mentioned above, the oat composition has a solids content between about 15 wt% and about 25 wt%, inclusively. Preferably, the oat composition has a solids content between about 20.5 wt% and about 22 wt%. The method 400 is able to yield between about 85 wt% and 90 wt% of the material used in the method 400. Such high yields are unusual in the industry. Alternatively, or in addition, the method 400 is able to yield between about 85 wt% and 90 wt% of a sum of the weights of the water, oat flour or whole out flour, first, second, third enzyme and enzyme blend used in the method 400. These yields are able to be achieved from the unique blend of enzymes used in the manufacturing method 400 as well as the temperature and pH controls.

The method 400 further includes a finished oat base step at step 440. The finished oat base step at step 440 includes using the oat composition for either making oat beverages, making fermented cups, or selling the oat composition as a commodity.

At least because the oat-based food composition is oat-based and not milk-based, the carbohydrates included in the oat-based food composition may include glucose and maltose, but the oat-based food composition is substantially free of lactose. In addition, at least because the oat-based food composition has undergone the method of manufacture described in the preceding paragraphs, the oat-based food composition has an increased shelf stability compared to conventional oat-based food compositions.

The method 400 optionally includes a quality assurance step, at step 04, to check, for example, temperature, pH, and solids content levels, and corrective measures, at step 406, may be taken if these, or other, parameters are outside of specification to put these, or other, parameters back into specification. If the temperature, pH, solids content levels are not to specification within any portion of the process, the desired functionality of the oat base and finished products may be detrimentally affected.

In some embodiments, a portion of the oat composition may be used in a recycle step and fed into a new batch for manufacturing the oat composition.

A particular, non-limiting embodiment of the oat composition is now discussed. In the particular embodiment, the oat composition includes water at an amount between about 54 wt% and about 55 wt%. In the particular embodiment, the oat composition further includes the oat-water mixture, discussed above and produced in the hydration step 202, in an amount between about 21 wt% and about 23 wt%. In the particular embodiment, the oat composition further includes food starch in an amount between about 3.2 wt% and about 3.5 wt%. In the particular embodiment, the oat composition further includes vegetable fat in an amount between about 2.9 wt% and about 3.55 wt%. In the particular embodiment, the oat composition further includes vegetable protein in an amount between about 4.75 wt% and about 5.4 wt%. In the particular embodiment, the oat composition further includes natural flavor additives in an amount between about 0.05 wt% and about 0.15 wt%. In the particular embodiment, the oat composition further includes fruit in an amount between about 10 wt% and about 12 wt%. In the particular embodiment, the oat composition further includes hydrocolloids in an amount between about 0.35 wt% and about 0.39 wt%. In the particular embodiment, the oat composition further includes citric acid in an amount between about 0.05 wt% and about 0.71 wt%. All of these ranges are inclusive of the endpoints. Though the word “about” is used to identify the endpoints of these ranges, the precise endpoint values are also contemplated to be used.

Further, as described above, the oat composition may be used in an oat beverage. A particular embodiment of the oat beverage is now discussed. In the particular embodiment, the oat beverage includes water in an amount between about 64.5 wt% and about 66 wt%. The particular embodiment of the oat beverage further includes the oat-water mixture discussed above and produced in the hydration step 202, in an amount between about 31 wt% and about 33 wt%. The particular embodiment of the oat beverage further includes vegetable oil in an amount between about 1.69 wt% and about 1.96 wt%. The particular embodiment of the oat beverage further includes dipotassium phosphate in an amount between about 0.32 wt% and about 0.40 wt%. The particular embodiment of the oat beverage further includes calcium carbonate in an amount between about 0.24 wt% and about 0.32 wt%. The particular embodiment of the oat beverage further includes tricalcium phosphate in an amount between about 0.09 wt% and about 0.12 wt %. The particular embodiment of the oat beverage further includes hydrocolloid in an amount between about 0.03 wt% and about 0.04 wt%. The particular embodiment of the oat beverage further includes sea salt in an amount between about 0.1 wt% and about 0.12 wt%. The particular embodiment of the oat beverage further includes other vitamins and minerals in an amount between about 0.03 wt% and about 0.04 wt%.

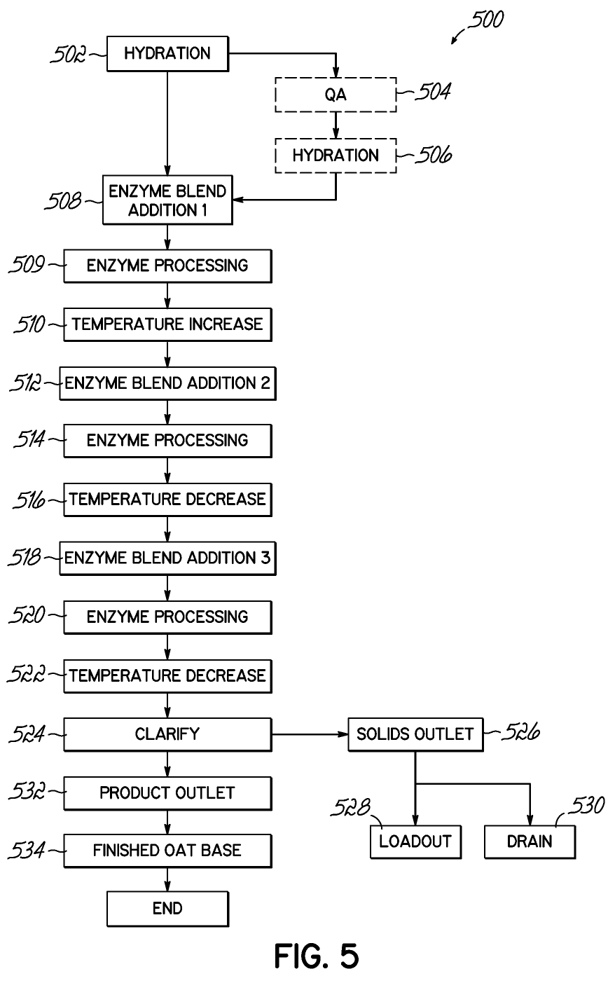

A flowchart of another embodiment in FIG. 5 includes a method 500 of manufacturing an oat-based food composition. The method 500 includes adding oat flour, whole oat flour containing the germ, bran, husk of oat, or mixtures thereof, to water to form an oat-water mixture at step 502. The method further includes, at step 508, adding a first enzyme blend between 0.02% and 3% inclusively, by weight, to the oat-water mixture to form a first enzyme oat-water mixture. The method 500 further includes increasing, at step 510, the temperature of the first enzyme oat-water mixture and adding, at step 512, a second enzyme blend to the first enzyme oat-water mixture after the step 510 to form a second enzyme oat-water mixture. The method 500 further includes a step 514 which may include enzyme processing and maintaining the temperature of the second enzyme oat-water mixture to allow for the first and second enzyme blends to further activate. The method 500 further includes cooling, at step 516, the second enzyme oat-water mixture. The method 500 further includes at step 518, adding a third enzyme blend to the second enzyme oat-water mixture to form a third enzyme oat-water mixture, and an enzyme processing step 520, which may include maintaining a temperature of the third enzyme oat-water mixture to allow for the third enzyme blend to process the third enzyme oat-water mixture. The method 500 further includes decreasing, at step 522, the temperature of the third enzyme oat-water mixture. The method 500 further includes clarifying, at step 524, the third enzyme oat-water mixture, which may include separating an amount of solids from the third enzyme oat-water mixture forming, at step 532/534, the oat composition. The amount of solids separated at step 526, from the third enzyme oat-water mixture may be drained, at step 530, and discarded or reused in a loadout, at step 528. The oat composition, thus formed, at step 532, from having the amount of solids separated from the third enzyme oat-water mixture may then be finished further to form a finished oat base. The method 500 is able to yield between about 85 wt% and 90 wt% of the material used in the method 500. Such high yields are unusual in the industry. Alternatively, or in addition, the method 500 is able to yield between about 85 wt% and 90 wt% of a sum of the weights of the water, oat flour or whole out flour, first enzyme, and enzyme blend used in the method 500. Further, oat-based food compositions prepared by method 500 have increased stability during storage and shelf-life of the oat-based food composition compared to conventional oat-based food compositions. In addition, the method 500 is able to produce less waste than conventional methods of manufacturing oat-based food compositions.

The method 500 for manufacturing the oat composition may be a batch method. Alternatively, the method 500 for manufacturing the oat-based food composition may be a continuous or semi-continuous method. In embodiments where a batch method is used, the batch size may be between about 1800 gallons and about 5400 gallons, inclusively (between about 6.8 kL and 20 kL, inclusively). In some embodiments, the batch size may be selected from a group consisting of about 1800 gallons, about 2400 gallons, about 4200 gallons, about 4800 gallons, and about 5400 gallons (selected from the group consisting of about 6.8 kL, about 9 kL, about 15.9 kL, about 18.2 kL, and about 20kL). The batch process may use only a single tank or a plurality of connected tanks. Alternatively, the batch process may use a plurality or nonconnected tanks.

The method 500 and steps of FIG. 5 will now be described in further detail. In some embodiments, the oat-water mixture may be formed in a hydration step, at step 502, by adding water and oat flour or whole oat flour to a liquefier or tank. The method 500 includes, in the step 502, hydrating oat flour by adding oat flour to water, in a tank for example, to form an oat-water mixture. The oat flour may be whole oat flour. The water may be present in an amount between about 70 wt% and about 80 wt% of the oat-water mixture. The balance of the weight of the oat-water mixture is oat flour or whole oat flour. Alternatively, or in addition, the oat flour or whole oat flour may be present in an amount between about 20 wt% to about 30 wt% in the oat-water mixture. In some embodiments, the oat-water mixture includes about 75 wt% of water and 25 wt% oat flour or whole oat flour. In some embodiments, the temperature of the oat-water mixture is between about 20^{o}C and about 30^{o}C, inclusively. Preferably, the temperature of the oat-water mixture is between about 10^{o}C and about 25^{o}C, inclusively. A step 504 may be a quality assurance step of the oat-water mixture and may be conducted to assure that the pH and solids weight percentage of the oat-water mixture is within specification. For example, the step 504 may be a step to assure that the pH of the oat-water mixture is between 6.5 and 7.5, inclusively. Alternatively, or in addition, in another example, the step 504 may be a step in assure that the solids weight percentage of the oat-water mixture is between 24% and 29%, inclusively. In some embodiments, corrective measures, such as additional hydration at step 506, which may include adding additional water, oat flour, whole oat flour, or mixtures thereof, to the oat-water mixture to bring the pH and solids weight percentage of the oat-water mixture into specification may occur. Quality assurance at step 504 is not limited to occurring only after hydration at step 502 but is included here merely as a non-limiting example. Quality assurance measures at step 504 may occur after any or all of the steps included in the method 500, and may include a variety of correction steps, such as hydration at step 506. The corrective step is not limited to hydration at step 506, but may alternatively or in addition, in a non-limiting list, include separating solids, increasing or decreasing temperature, adding enzymes, adding oat flour, or allowing for additional time for enzyme activation. Each of these steps is accomplished while the oat-water enzyme mixture maintains a pH between 6.5 and 7.2, inclusively.

The method 500 further includes adding a first enzyme blend at step 508 to the oat-water mixture to form a first enzyme oat-water mixture. The first enzyme blend is added to the oat-water mixture when the oat-water mixture is at a temperature of between about 10^{o}C and about 30^{o}C, inclusively. Alternatively, the first enzyme blend is added to the oat-water mixture when the temperature of the oat-water mixture is between about 10^{o}C and about 25^{o}C, inclusively. The first enzyme blend acts to reduce the viscosity of the oat-water mixture during subsequent steps. In this way, the first enzyme oat-water mixture has a lower viscosity than the oat-water mixture. In one embodiment, the first enzyme blend may include bacterial α-amylase, fungal α-amylase, bacterial β-glucanase, fungal β-glucanase, other peroxidases, protein deamidase, or mixtures thereof. In further embodiments, the first enzyme blend may include bacterial α-amylase, fungal α-amylase, bacterial β-amylase, fungal β-amylase, bacterial glucose oxidase, fungal glucose oxidase, other peroxidases, protein deamidase, or mixtures thereof.

The method 500 further includes increasing the temperature at step 510 of the first enzyme oat-water mixture. As mentioned above, the temperature of the first enzyme oat-water mixture may originally be between about 10^{o}C and about 30^{o}C, inclusively. The temperature of the first enzyme oat-water mixture is increased at step 510 to be between 60^{o}C and 70⁰C, inclusively. In some embodiments, the temperature of the first enzyme oat-water mixture is increased to between about 60^{o}C and 75^{o}C, inclusively.

The method 500 further includes adding a second enzyme blend at step 512 to the first enzyme oat-water mixture to form the second enzyme oat-water mixture. The second enzyme blend at step 512 is added after the temperature of the first enzyme oat-water mixture is increased in temperature at step 510, when the first enzyme oat-water mixture has a temperature of between about 60^{o}C and 70⁰C, or preferably, when the first enzyme oat-water mixture has a temperature of between about 60^{o}C and about 75^{o}C, inclusively. At least because the temperature of the first enzyme oat-water mixture has already been increased, the second enzyme blend added to the first enzyme oat-water mixture is activated soon after its addition and formation of the second enzyme oat-water mixture.

The second enzyme blend acts to reduce the viscosity of the oat-water mixture during subsequent steps. In this way, the second enzyme oat-water mixture has a lower viscosity than the first enzyme oat-water mixture. In one embodiment, the second enzyme blend may include bacterial α-amylase, fungal α-amylase, bacterial β-glucanase, fungal β-glucanase, other peroxidases, or mixtures thereof. In further embodiments, the second enzyme blend may include bacterial α-amylase, fungal α-amylase, bacterial β-amylase, fungal β-amylase, bacterial glucose oxidase, fungal glucose oxidase, other peroxidases, protein deamidase, or mixtures thereof.

The method 500 further includes a processing step at step 514 to allow the second enzyme blend in the second enzyme oat-water mixture to activate and process the second enzyme oat-water mixture. The processing step at step 514 may last from about 30 minutes to about 90 minutes. Preferably, the processing step at step 514 occurs for about 60 minutes. During the processing step at step 514, the temperature of the second enzyme oat-water mixture is maintained at between about 60^{o}C and 70⁰C, inclusively. Alternatively, during the processing step at step 514, the temperature of the second enzyme oat-water mixture is maintained between about 60^{o}C and 75⁰C, inclusively.

The method 500 further includes a temperature decreasing step at step 516. During the temperature decreasing step at step 516, the temperature of the second enzyme oat-water mixture is reduced to between about 50⁰C and 60^{o}C, inclusively. The temperature decreasing step at step 516 is done in preparation of the addition of a third enzyme blend into the second enzyme oat-water mixture.

The method 500 further includes adding a third enzyme blend between 0.02% – 3% by weight to the blend at step 518 to the second enzyme oat-water mixture to form a third enzyme oat-water mixture, and an enzyme processing step at step 520. The third enzyme blend is added to the second enzyme oat-water mixture after the second enzyme oat-water mixture has had its temperature become between about 50^{o}C and about 60^{o}C, inclusively. The third enzyme blend added to the second enzyme oat-water mixture include enzymes that perform sensory functions as well as viscosity reduction and enzyme efficiency functions. In some embodiments, the third enzyme blend may include a bacterial α-amylase, a fungal α-amylase, a bacterial β-amylase, a fungal β-amylase, a bacterial glucoamylase, a fungal glucoamylase, a bacterial glucose oxidase, a fungal glucose oxidase, other peroxidase enzymes, or mixtures thereof. In some embodiments, the bacterial α-amylase, fungal α-amylase, bacterial β-amylase, or fungal β-amylase performs a viscosity reduction function as well as an enzyme efficiency function. In this way, the third enzyme oat-water mixture has a lower viscosity than the second enzyme oat-water mixture. Alternatively, or in addition, the β-amylase and the glucoamylase have sensory functions and improve the mouthfeel of the oat-water enzyme blend. Individually and in combination, the enzyme blends added to the second enzyme oat-water mixture help improve taste, mouthfeel and over all sensorial experience of the enzyme oat-water mixture.

The method 500 further includes a processing step at step 520 to allow the third enzyme blend in the third enzyme oat-water mixture to activate and process the third enzyme oat-water mixture. The processing step at step 520 may last from about 1 minute to about 60 minutes. Preferably, the processing step at step 520 occurs for about 30 minutes to about 60 minutes. Even more preferably, the processing step at step 520 occurs for about 45 minutes. During the processing step at step 520, the temperature of the third enzyme oat-water mixture is maintained at between about 50^{o}C and about 60^{o}C, inclusively.

Optionally, method 500 further includes a temperature decreasing step at step 522. During the temperature decreasing step at step 522, the temperature of the third enzyme oat-water mixture is reduced to about between 40^{o}C and about 60^{o}C, inclusively. Preferably, the temperature of the third enzyme oat-water mixture is reduced to between about 40^{o}C and about 50^{o}C. Even more preferably, the temperature of the third enzyme oat-water mixture is adjusted to be about 47^{o}C. The temperature decreasing step at step 522 is done to facilitate the separation of solids from the third enzyme oat-water mixture. The temperature decreasing step at step 522 is also done to reduce losses of solids that would occur during separation at higher temperatures.

The method 500 further includes a clarifying step at step 524. During the clarifying step, the third enzyme oat-water mixture is centrifuged to clarify the solid particulate in the third enzyme oat-water mixture from the liquid. An amount of the solids included in the third enzyme oat-water mixture is removed at step 526, either during the clarification step at step 524 or after the clarification step at step 524, resulting in the oat composition. The third enzyme oat-water mixture has a solids content of between about 20 wt% and about 30 wt%, inclusively, prior to removal of the amount of solids content. Preferably, in some embodiments, the third enzyme oat-water mixture has a solids content of between about 23.5 wt% and about 25 wt%, inclusively, of the third enzyme oat-water mixture. During the clarification step at step 524 or after the clarification step at step 524, an amount of solids from the third enzyme oat-water mixture is removed at step 526 from the third enzyme oat-water mixture resulting in the oat composition. The oat composition has a solids content between about 15 wt% and about 25 wt%, inclusively. Preferably, the oat composition has a solids content between about 20.5 wt% and about 22 wt%.

The solids removed from the third enzyme oat-water mixture may either be collected in a loadout step at step 528 or may be drained at step 530 from the system. The loadout step at step 528 may include collecting the solids removed from the third enzyme oat-water mixture may be used in a recycle step, sold, destroyed, or used in other processes. The solids removed from the third enzyme oat-water mixture may alternatively or in addition to the loadout step at step 528, be drained at step 530 from the system and discarded as waste.

The method 500 further includes a product outlet step at step 532. The product outlet step at step 532 includes the oat composition. As mentioned above, the oat composition has a solids content between about 15 wt% and about 25 wt%, inclusively. Preferably, the oat composition has a solids content between about 20.5 wt% and about 22 wt%. The method 500 is able to yield between about 85 wt% and 90 wt% of the material used in the method 500. Such high yields are unusual in the industry. Alternatively, or in addition, the method 500 is able to yield between about 85 wt% and 90 wt% of a sum of the weights of the water, oat flour or whole out flour, first enzyme, and enzyme blend used in the method 500. These yields are able to be achieved from the unique blend of enzymes used in the manufacturing method 500 as well as the temperature and pH controls.

The method 500 further includes a finished oat base step at step 534. The finished oat base step at step 534 includes using the oat composition for either making oat beverages, making fermented cups, or selling the oat composition as a commodity.

At least because the oat-based food composition is oat-based and not milk-based, the carbohydrates included in the oat-based food composition may include glucose and maltose, but the oat-based food composition is substantially free of lactose. In addition, at least because the oat-based food composition has undergone the method of manufacture described in the preceding paragraphs, the oat-based food composition has an increased shelf stability compared to conventional oat-based food compositions.

The method 500 optionally includes a quality assurance step, at step 504, to check, for example, temperature, pH, and solids content levels, and corrective measures, at step 506, may be taken if these, or other, parameters are outside of specification to put these, or other, parameters back into specification. If the temperature, pH, solids content levels are not to specification within any portion of the process, the desired functionality of the oat base and finished products may be detrimentally affected.

In some embodiments, a portion of the oat composition may be used in a recycle step and fed into a new batch for manufacturing the oat composition.

A particular, non-limiting embodiment of the oat composition is now discussed. In the particular embodiment, the oat composition includes water at an amount between about 54 wt% and about 55 wt%. In the particular embodiment, the oat composition further includes the oat-water mixture, discussed above and produced in the hydration step 502, in an amount between about 21 wt% and about 23 wt%. In the particular embodiment, the oat composition further includes food starch in an amount between about 3.2 wt% and about 3.5 wt%. In the particular embodiment, the oat composition further includes vegetable fat in an amount between about 2.9 wt% and about 3.55 wt%. In the particular embodiment, the oat composition further includes vegetable protein in an amount between about 4.75 wt% and about 5.4 wt%. In the particular embodiment, the oat composition further includes natural flavor additives in an amount between about 0.05 wt% and about 0.15 wt%. In the particular embodiment, the oat composition further includes fruit in an amount between about 10 wt% and about 12 wt%. In the particular embodiment, the oat composition further includes hydrocolloids in an amount between about 0.35 wt% and about 0.39 wt%. In the particular embodiment, the oat composition further includes citric acid in an amount between about 0.05 wt% and about 0.71 wt%. All of these ranges are inclusive of the endpoints. Though the word “about” is used to identify the endpoints of these ranges, the precise endpoint values are also contemplated to be used.

Further, as described above, the oat composition may be used in an oat beverage. A particular embodiment of the oat beverage is now discussed. In the particular embodiment, the oat beverage includes water in an amount between about 64.5 wt% and about 66 wt%. The particular embodiment of the oat beverage further includes the oat-water mixture discussed above and produced in the hydration step 202, in an amount between about 31 wt% and about 33 wt%. The particular embodiment of the oat beverage further includes vegetable oil in an amount between about 1.69 wt% and about 1.96 wt%. The particular embodiment of the oat beverage further includes dipotassium phosphate in an amount between about 0.32 wt% and about 0.40 wt%. The particular embodiment of the oat beverage further includes calcium carbonate in an amount between about 0.24 wt% and about 0.32 wt%. The particular embodiment of the oat beverage further includes tricalcium phosphate in an amount between about 0.09 wt% and about 0.12 wt %. The particular embodiment of the oat beverage further includes hydrocolloid in an amount between about 0.03 wt% and about 0.04 wt%. The particular embodiment of the oat beverage further includes sea salt in an amount between about 0.1 wt% and about 0.12 wt%. The particular embodiment of the oat beverage further includes other vitamins and minerals in an amount between about 0.03 wt% and about 0.04 wt%. To clarify the use of and to hereby provide notice to the public, the phrases "at least one of <A>, <B>, … and <N>" or "at least one of <A>, <B>, … <N>, or combinations thereof" or "<A>, <B>, … and/or <N>" are defined by the Applicant in the broadest sense, superseding any other implied definitions hereinbefore or hereinafter unless expressly asserted by the Applicant to the contrary, to mean one or more elements selected from the group comprising A, B, … and N. In other words, the phrases mean any combination of one or more of the elements A, B, … or N including any one element alone or the one element in combination with one or more of the other elements which may also include, in combination, additional elements not listed. All of the ranges of parameters described herein are inclusive of the endpoints. Though the word “about” is used to identify the endpoints of parameter ranges, the precise endpoint values are also contemplated to be used.

Further, as described above, the oat composition may be used in an oat beverage. In one embodiment, the oat composition may be used in coffee or coffee-based drinks. The oat composition through the above embodiments improves protein solubility, which results in improved foaming of the oat composition when used in an oat beverage. In a further embodiment, the enhanced protein solubility of the oat composition enhances the foaming characteristics when used in coffee or coffee-based beverages.

While various embodiments have been described, it will be apparent to those of ordinary skill in the art that many more embodiments and implementations are possible. Accordingly, the embodiments described herein are examples, not the only possible embodiments and implementations.

What is claimed is:

1. A method of making an oat-based food composition, comprising:
adding oat flour to water to form an oat-water mixture;
adding a first enzyme blend to the oat-water mixture to form a first enzyme oat-water mixture;
increasing the temperature of the first enzyme oat-water mixture to between 75°C to 95°C, inclusively;
adding a second enzyme blend to the first enzyme oat-water mixture after increasing the temperature of the first enzyme oat-water mixture to form a second enzyme-oat water mixture;
maintaining, in a processing step, a temperature of the second enzyme oat-water mixture at between 75°C and 95°C for a time period of 1 minute to 20 minutes;
cooling the second enzyme oat-water mixture to a temperature between 60°C and 70°C, inclusive;
adding a third enzyme blend to the second enzyme oat-water mixture to form a third enzyme oat-water mixture;
maintaining, in a further processing step, a temperature of the third enzyme oat-water mixture between 60°C and 70°C for a time period of 45 minutes to 60 minutes;
cooling the third enzyme oat-water mixture to a temperature between 50°C and 60°C, inclusive;
adding a fourth enzyme blend to the third enzyme oat-water mixture to form a fourth enzyme oat-water mixture;
maintaining, in another processing step, a temperature of the fourth enzyme oat-water mixture between 50°C and 60°C for a time period of 30 minutes to 60 minutes; and
removing an amount of solids from the fourth enzyme oat-water mixture to form an oat composition.

2. The method of claim 1, wherein the first enzyme blend comprises bacterial α-amylase.

3. The method of claim 2, wherein the second enzyme blend comprises the same bacterial α-amylase as the first enzyme blend.

4. The method of claim 1, wherein the second enzyme blend comprises bacterial α-amylase.

5. The method of claim 1, wherein the third enzyme blend comprises protein glutaminase.

6. The method of claim 1, wherein the fourth enzyme blend comprises fungal α-amylase, bacterial β-amylase, and fungal glucoamylase.

7. The method of claim 6, wherein the first enzyme blend comprises bacterial α-amylase, the second enzyme blend comprises the same bacterial α-amylase as the first enzyme blend, and the third enzyme blend comprises protein glutaminase.

8. The method of claim 1, wherein:
the processing step of the second enzyme oat-water mixture is performed at about 80°C for about 10 minutes;
the further processing step of the third enzyme oat-water mixture is performed at about 65°C for about 45 minutes to 60 minutes; and
the another processing step of the fourth enzyme oat-water mixture is performed at about 55°C for about 45 minutes.

9. The method of claim 1, wherein the oat-water mixture has a temperature of between 20^{o}C and 30^{o}C, inclusively, before adding the first enzyme blend.

10. The method of claim 1, wherein the oat-based food composition comprises a carbohydrate, the carbohydrate being at least one of maltose and glucose, and wherein the oat-based food composition is substantially free of lactose.

11. A method for making an oat-based food composition, comprising:
adding oat flour to water to form an oat-water mixture;
adding a first enzyme blend to the oat-water mixture to form a first enzyme oat-water mixture;
conducting enzyme processing by maintaining the first enzyme oat-water mixture in a tank for 45 minutes to 75 minutes;
increasing the temperature of the first enzyme oat-water mixture to between 60°C and 70°C, inclusively;
adding a second enzyme blend to the first enzyme oat-water mixture after increasing the temperature of the first enzyme oat-water mixture to between 60°C and 70°C, inclusively, to form a second enzyme oat-water mixture;
maintaining, in a further processing step, a temperature of the second enzyme oat-water mixture between 60°C and 70°C for about 45 minutes to 75 minutes;
cooling the second enzyme oat-water mixture to a temperature between 50°C and 60°C, inclusive;
adding a third enzyme blend to the second enzyme oat-water mixture to form a third enzyme oat-water mixture;
maintaining, in another processing step, a temperature of the third enzyme oat-water mixture between 50°C and 60°C for 30 minutes to 60 minutes; and
removing an amount of solids from the third enzyme oat-water mixture to form an oat composition.

12. The method of claim 11, wherein the first enzyme blend comprises α-amylase, β-glucanase, and protein glutaminase.

13. The method of claim 11, wherein the second enzyme blend comprises α-amylase and β-glucanase.

14. The method of claim 11, wherein the third enzyme blend comprises fungal α-amylase, bacterial β-amylase, and fungal glucoamylase.

15. The method of claim 14, wherein the first enzyme blend comprises α-amylase, β-glucanase, and protein glutaminase, and the second enzyme blend comprises the same α-amylase and β-glucanase as in the first enzyme blend.

16. The method of claim 11, wherein:
the enzyme processing of the first enzyme oat-water mixture is performed for about 60 minutes;
the further processing step of the second enzyme oat-water mixture is performed at about 65°C for about 60 minutes; and
the another processing step of the third enzyme oat-water mixture is performed at about 55°C for about 45 minutes.

17. The method of claim 11, wherein the oat-water mixture has a temperature of between 20^{o}C and 30^{o}C, inclusively, before adding the first enzyme blend.

18. The method of claim 11, wherein the oat-based food composition comprises a carbohydrate, the carbohydrate being at least one of maltose and glucose, and wherein the oat-based food composition is substantially free of lactose.
